(19) United States
(12) Patent Application Publication
(10) Pub. No.: US 2025/0067930 A1
(43) Pub. Date: Feb. 27, 2025

(54) PHOTONIC INTEGRATED APPARATUS

(71) Applicant: Samsung Electronics Co., Ltd., Suwon-si (KR)

(72) Inventors: Bongyong JANG, Suwon-si (KR); Eunkyung LEE, Suwon-si (KR); Dongsik SHIM, Suwon-si (KR)

(73) Assignee: Samsung Electronics Co., Ltd., Suwon-si (KR)

(21) Appl. No.: 18/597,121

(22) Filed: Mar. 6, 2024

(30) Foreign Application Priority Data
Aug. 25, 2023 (KR) 10-2023-0112280

(51) Int. Cl. G02B 6/122; G02B 6/12

(52) U.S. Cl. CPC G02B 6/122; G02B 2006/12102; G02B 2006/12104

(57) ABSTRACT

A photonic integrated apparatus includes a substrate, a dielectric layer disposed on the substrate and including an opening exposing a part of the substrate, a photonic source contacting a partial area of the substrate through the opening, a waveguide disposed on the dielectric layer, and a photonic steering device disposed on the dielectric layer and configured to steer light emitted from the photonic source to the waveguide.

### CROSS-REFERENCE TO RELATED APPLICATION

This application is based on and claims priority under 35 U.S.C. § 119 to Korean Patent Application No. 10-2023-0112280, filed on Aug. 25, 2023, in the Korean Intellectual Property Office, the disclosure of which is incorporated by reference herein in its entirety.

### BACKGROUND

### 1. Field

The disclosure relates to a photonic integrated apparatus, and more particularly, to a photonic integrated apparatus including a photonic device and a waveguide which are monolithically formed on a substrate.

### 2. Description of the Related Art

Photonic integrated circuits and/or photonic integrated apparatuses in which photonic devices are integrated may be used in various photonic sensor or photonic connection fields. Photonic devices used in photonic integrated apparatuses include a photonic source that converts electrical energy into photonic energy, a photonic modulator that modulates light, a waveguide that transmits a photonic signal, a photonic antenna or photonic coupler that sends light inside the waveguide to outside of a photonic integrated circuit chip or receives light outside the photonic integrated circuit chip into the waveguide, a photonic detector that converts light energy into electrical energy, etc.

There is a need to increase light coupling efficiency and reduce the volume of photonic integrated apparatus by forming various photonic devices on one substrate.

### SUMMARY

Provided is a photonic integrated apparatus in which a photonic device and a waveguide are monolithically disposed on one substrate.

Provided is a photonic integrated apparatus that increases light coupling efficiency between a photonic device and a waveguide.

Additional aspects will be set forth in part in the description which follows and, in part, will be apparent from the description, or may be learned by practice of the presented embodiments of the disclosure.

According to an aspect of the disclosure, a photonic integrated apparatus includes a substrate; a dielectric layer on the substrate, the dielectric layer defining an opening exposing a part of the substrate; a photonic source contacting a partial area of the substrate through the opening; a waveguide on the dielectric layer, and a photonic steering device on the dielectric layer and configured to steer light emitted from the photonic source to the waveguide.

A partial area of at least one side surface of the photonic source may be in contact with the dielectric layer.

The substrate may include one or more grooves.

The one or more grooves may expose a (111) surface of the substrate.

The photonic source may fill at least one of the one or more grooves.

The photonic source may include a first semiconductor layer in contact with a partial area of the substrate, a second semiconductor layer above and the first semiconductor layer, and an active layer between the first semiconductor layer and the second semiconductor layer, and a portion of the first semiconductor layer may protrude from the dielectric layer.

The first semiconductor layer may include a first sub-semiconductor layer surrounded by the dielectric layer, and a second sub-semiconductor layer on the first sub-semiconductor layer and having a width different from a width of the first sub-semiconductor layer.

The width of the second sub-semiconductor layer may be greater than the width of the first sub-semiconductor layer.

The photonic steering device may focus the light emitted from the photonic source toward the waveguide.

The light emitted from the photonic source may be incident on a curved surface of the photonic steering device.

The photonic steering device may include a convex lens shape.

The photonic steering device may be in contact with at least one of an upper surface or a side surface of the waveguide.

The waveguide may overlap a part of the photonic steering device in a thickness direction of the substrate.

A refractive index of the photonic steering device may be less than or equal to a refractive index of the waveguide.

The substrate may include a semiconductor.

The substrate, the dielectric layer, the photonic source, and the waveguide may have a monolithic structure.

The substrate, the dielectric layer, and the waveguide may be patterned from a silicon on insulator (SOI) substrate.

The photonic integrated apparatus may further include an anti-reflective layer on at least a part of a surface of the photonic source, facing the photonic steering device.

The photonic integrated apparatus may further include a reflective layer on at least a part of a surface of the photonic source not facing the photonic steering device.

The photonic integrated apparatus may further include a reflector on the photonic steering device and configured to reflect incident light emitted from the photonic source.

The photonic integrated apparatus may further include an additional dielectric layer over the waveguide, and an additional waveguide over the additional dielectric layer and configured to transmit the light emitted from the photonic steering device to the waveguide through light coupling.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a cross-sectional view illustrating a photonic integrated apparatus according to at least one embodiment;

FIG. 1B is a cross-sectional view taken along line A-A′ of FIG. 1A;

FIG. 2 is a diagram illustrating a photonic integrated apparatus further including an anti-reflective layer and a reflective layer according to at least one embodiment;

FIG. 3 is a diagram illustrating a photonic integrated apparatus in which a waveguide and a photonic steering device overlap according to at least one embodiment;

FIG. 4 is a diagram illustrating a photonic integrated apparatus including a reflector according to at least one embodiment;

FIG. 5 is a diagram illustrating a photonic integrated apparatus including a diffractive optical device according to at least one embodiment;

FIG. 6 is a diagram illustrating a photonic integrated apparatus including a photonic coupler according to at least one embodiment;

FIG. 7 is a diagram illustrating a photonic integrated apparatus including a waveguide having a tapered shape according to at least one embodiment;

FIG. 8 is a diagram illustrating a photonic integrated apparatus including a plurality of waveguides according to at least one embodiment;

FIG. 9 is a diagram illustrating a photonic integrated apparatus including a second waveguide according to at least one embodiment;

FIG. 10 is a diagram illustrating a photonic integrated apparatus including a waveguide and a photonic detector according to at least one embodiment; and

FIG. 11 is a perspective view schematically illustrating a configuration of a phase array device which is an example of a photonic integrated apparatus according to at least one embodiment.

### DETAILED DESCRIPTION

Reference will now be made in detail to some embodiments, examples of which are illustrated in the accompanying drawings, wherein like reference numerals refer to like elements throughout. In this regard, unless otherwise stated or clear from context, none of the example embodiments are necessarily mutually exclusive to one another. While one or more example embodiments have been described with reference to the figures, it will be understood by those of ordinary skill in the art that the present embodiments may have different forms and should not be construed as being limited to the descriptions set forth herein. Accordingly, the embodiments are merely described below, by referring to the figures, to explain aspects.

As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments will be described with reference to the accompanying drawings. In the drawings, the sizes of elements may be exaggerated for clarity of illustration. The embodiments described herein are for illustrative purposes only, and various modifications may be made therein.

In the following description, when an element is referred to as being “above” or “on” another clement, it may be directly on an upper, lower, left, or right side of the other element while making contact with the other element or may be above an upper, lower, left, or right side of the other element without making contact with the other element. Additionally, spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, device may be otherwise oriented, for example, rotated 90 degrees or at other orientations, and the spatially relative descriptors used herein should be interpreted accordingly. The terms of a singular form may include plural forms unless otherwise mentioned. It will be further understood that the terms “comprises” and/or “comprising” used herein specify the presence of stated features or elements, but do not preclude the presence or addition of one or more other features or elements.

An element referred to with the definite article or a demonstrative pronoun may be construed as the element or the elements even though it has a singular form. Operations of methods herein may be performed in any suitable order unless clearly specified herein or contradicted by context.

The disclosure is not limited to the described order of the operations.

Also, terms such as “processor,” “unit,” and/or “module” used herein may be used to denote a unit that has at least one function or operation and is implemented with processing circuitry such as hardware, software, and/or a combination of hardware and software. For example, the processing circuitry more specifically may include (and/or be included in), but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Line connections or connection members between elements depicted in the drawings represent functional connections and/or physical or circuit connections by way of example, and in actual applications, they may be replaced or embodied with various additional functional connections, physical connections, or circuit connections.

Although terms such as “first” and “second” may be used herein to describe various elements or components, these elements or components should not be limited by these terms. These terms are only used to distinguish one element or component from another element or component.

All examples or exemplary terms are just used herein to describe technical ideas and should not be considered for purposes of limitation unless defined by the claims. Additionally, when the terms “about” or “substantially” are used in this specification in connection with a numerical value, it is intended that the associated numerical value includes a manufacturing tolerance (e.g., ±10%) around the stated numerical value. Further, regardless of whether numerical values are modified as “about” or “substantially,” it will be understood that these values should be construed as including a manufacturing or operational tolerance (e.g., ±10%) around the stated numerical values. When referring to “C to D”, this means C inclusive to D inclusive unless otherwise specified.

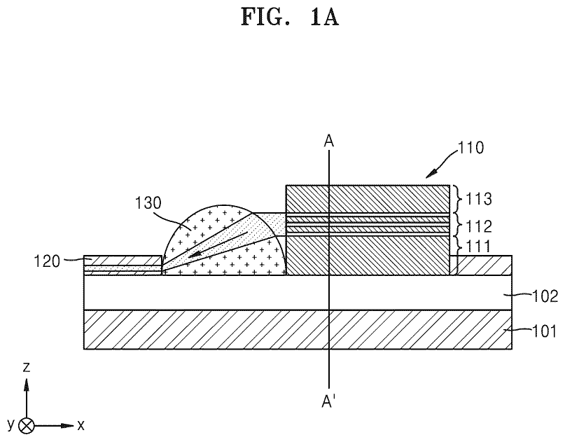

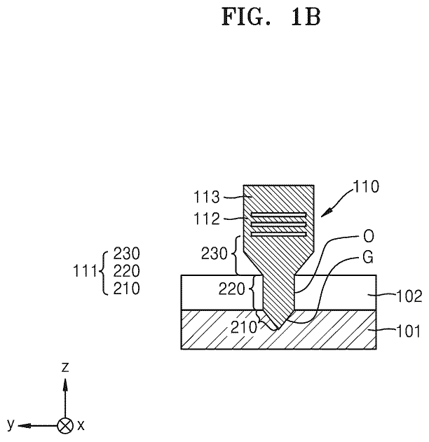

FIG. 1A is a cross-sectional view illustrating a photonic integrated apparatus according to at least one embodiment. FIG. 1B is a cross-sectional view taken along line A-A′ of FIG. 1A.

Referring to FIGS. 1A and 1B, the photonic integrated apparatus may include a substrate 101, a dielectric layer 102 disposed on the substrate 101 and including an opening O exposing a part of the substrate 101, a photonic source 110 in contact with the substrate 101 through the opening O, a waveguide 120 disposed on the dielectric layer 102, and a photonic steering device 130 disposed on the dielectric layer 102 and configured to steer light emitted from the photonic source 110 to the waveguide 120.

FIGS. 1A and 1B illustrate the photonic source 110 and the waveguide 120 as photonic devices of the photonic integrated apparatus, but the disclosure is not limited thereto. The photonic integrated apparatus may include various photonic devices other than the photonic source 110 and the waveguide 120. For example, the photonic integrated apparatus may also include a photonic amplifier, a photonic modulator, a photonic coupler 160, a photonic detector, etc.

The substrate 101 may include a semiconductor material. For example, the substrate 101 may be an elemental semiconductor substrate such as a silicon (Si) substrate and/or a germanium (Ge) substrate, and/or a compound semiconductor substrate such as GaP, GaAs, InP, GaN, and/or the like. For example, the substrate 101 may include a silicon substrate. However, a material of the substrate 101 is not necessarily limited thereto, and various wafer materials used in a semiconductor manufacturing process may be used as the substrate 101.

One or more grooves G may be disposed in the substrate 101. One groove G is shown in the drawing, but the disclosure is not limited thereto. A plurality of grooves G may be disposed in a surface of the substrate 101. In at least one embodiment, a (111) surface of the substrate 101 may be exposed to the outside through the groove G. In at least one embodiment, the photonic source 110 may be easily grown on the substrate 101 through the groove G described above.

The dielectric layer 102 may be disposed on the substrate 101. The dielectric layer 102 may include oxide. For example, the dielectric layer 102 may be silicon oxide (SiO2), but is not necessarily limited thereto. For example, the dielectric layer 102 may include at least one of an insulating silicon compound and/or an insulating metal compound in addition to silicon oxide. The insulating silicon compound may include, for example, silicon nitride (SixNy), silicon oxynitride (SiON), etc., and the insulating metal compound may include, for example, aluminum oxide (A12O₃), hafnium oxide (HfO), and zirconium oxide (ZrO), hafnium silicon oxide (HfSiO), titanium oxide (TiO₂), etc.

The dielectric layer 102 may include the opening O that exposes a part of the substrate 101. The groove G formed in the substrate 101 may overlap with the opening O in a thickness direction of the substrate 101. The entire groove G may overlap with the opening O.

The waveguide 120 may be disposed on the dielectric layer 102. The waveguide 120 may include a material with a refractive index greater than that of the dielectric layer 102. In at least one embodiment, the waveguide 120 may include a semiconductor material. For example, the waveguide 120 may include at least one of silicon and/or a nitride semiconductor. The substrate 101, the dielectric layer 102, and the waveguide 120 may be formed as a single Si on Insulator (SOI) substrate. For example, the waveguide 120 may be formed by partially patterning a silicon layer in the SOI substrate.

The photonic source 110 may be disposed to be in contact with the substrate 101. For example, the photonic source 110 may contact the substrate 101 through the opening O of the dielectric layer 102. A partial area of the photonic source 110 is impregnated in the substrate 101. For example, the photonic source 110 may extend in the thickness direction of the substrate 101 while filling the groove G formed in the substrate 101. A partial area of the side surfaces of the photonic source 110 may be surrounded by the dielectric layer 102. For example, the partial area of the side surfaces of the photonic source 110 may be in contact with the dielectric layer 102.

The photonic source 110 may include a first semiconductor layer 111, an active layer 112, and a second semiconductor layer 113.

The first semiconductor layer 111 may include, for example, an n-type semiconductor. However, the first semiconductor layer 111 is not necessarily limited thereto, and in some cases, may include a p-type semiconductor. For example, the first semiconductor layer 111 may include a group III-V n-type semiconductor and/or a group II-VI n-type semiconductor. Here, a nitride semiconductor may include, for example, GaN, InN, AIN, and/or a combination thereof, but is not limited thereto. For example, the first semiconductor layer 111 may include n-GaN.

The active layer 112 may be disposed on the first semiconductor layer 111. The active layer 112 may generate light in a certain wavelength band by combining electrons and holes. The active layer 112 may have a multi-quantum well (MQW) structure. However, the active layer 112 is not necessarily limited thereto, and in some cases, may have a single-quantum well (SQW) structure. The active layer 112 may include a group III-V semiconductor or a group II-VI semiconductor. For example, the active layer 112 may include GaN.

The second semiconductor layer 113 may be disposed on the active layer 112. The second semiconductor layer 113 may have an opposite charge type compared to the first semiconductor layer 111. For example, the second semiconductor layer 113 may include a p-type semiconductor. However, the second semiconductor layer 113 is not necessarily limited thereto, and in some cases, may include an n-type semiconductor. The second semiconductor layer 113 may include a group III-V p-type semiconductor or a group II-VI semiconductor. For example, the second semiconductor layer 113 may include p-GaN.

In general, a photonic integrated circuit including a waveguide may include a compound semiconductor such as silicon or silicon nitride. On the other hand, the photonic source 110 may include a group III-V compound semiconductor and/or a group II-VI compound semiconductor. The photonic source 110 and the photonic integrated circuit include different materials, and thus, the photonic source 110 may be manufactured independently and then connected to the photonic integrated circuit by using an optical fiber, etc. However, the photonic fiber has problems in that light coupling efficiency between the photonic source 110 and the photonic integrated circuit deteriorate, and the volume of the photonic fiber increases.

A photonic source integrated photonic integrated apparatus may be required to implement a compact photonic integrated circuit. To implement the photonic source integrated photonic integrated apparatus, the photonic source 110 may be manufactured separately and then bonded or transferred to the photonic integrated apparatus. However, misalignment may occur during a bonding or transfer process, which may reduce light coupling efficiency.

Alternatively, the photonic source 110 may be manufactured after bonding the base substrate, such as a group III-V, to the photonic integrated apparatus. Areas of the base substrate other than an area where the photonic source 110 is formed are discarded, causing a problem of increased manufacturing costs.

The photonic integrated apparatus according to at least one embodiment may have the photonic source 110 grown directly on the substrate 101. For example, the photonic source 110 may be formed using a selective epitaxial growth method. For example, a lower silicon layer, that is, a partial area of the substrate 101, may be exposed by removing the silicon layer of the SOI substrate and forming the opening O in the dielectric layer 102. As such the crystal lattice of the photonic source 110 may be aligned with the lattice structure of the exposed surface of the substrate 101 from which the photonic source 110 is grown. The one or more grooves G may be formed in the exposed area of the substrate 101. The surface 111 of the substrate 101 may be exposed by the groove G described above. The photonic source 110 may be formed on the (111) surface of the substrate 101 using a selective epitaxial growth method.

Meanwhile, because the substrate 101 and the photonic source 110 have different lattice constants, lattice defects may occur when the photonic source 110 is grown on the substrate 101. The lattice defects described above may impair the quantum efficiency of the photonic source 110. In order to remove the lattice defects described above, a thickness of the epitaxially grown first semiconductor layer 111 may be increased. The thickness of the first semiconductor layer 111 may be greater than a thickness of the dielectric layer 102 so that the first semiconductor layer 111 may be derived from a surface of the dielectric layer 102. Here, the thickness may mean an average thickness of the first semiconductor layer 111.

For example, the first semiconductor layer 111 may include a first sub-semiconductor layer 210 impregnated in the substrate 101, a second sub-semiconductor layer 220 surrounded by the dielectric layer 102, and a third sub-semiconductor layer 230 protruding from the dielectric layer 102. The first to third sub-semiconductor layers 210, 220, and 230 may have different widths. For example, the width of the first sub-semiconductor layer 210 may be smaller than the width of the second sub-semiconductor layer 220, and the width of the second sub-semiconductor layer 220 may be smaller than the width of the third sub-semiconductor layer 230. Here, the width may mean an average width of a layer. The first sub-semiconductor layer 210 may include a tapered area gradually increasing in width towards the second sub-semiconductor layer 220. The third sub-semiconductor layer 230 may include a tapered area gradually increasing in width towards the active layer 112.

Because the photonic source 110 is formed by growing directly on the substrate 101, the substrate 101, the dielectric layer 102, and the photonic source 110 may have a monolithic structure. For example, when the waveguide 120 is formed as the SOI substrate, the substrate 101, the dielectric layer 102, the waveguide 120, and the photonic source 110 may have the monolithic structure.

As the thickness of the first semiconductor layer 111 increases, a height difference between the active layer 112 of the photonic source 110 and the waveguide 120 may increase. In order to mitigate the effects of this height difference, the photonic integrated apparatus according to at least one embodiment may include the photonic steering device 130 that steers the light emitted from the photonic source 110 to the waveguide 120. The photonic steering device 130 may be disposed between the photonic source 110 and the waveguide 120 on the dielectric layer 102. The light incident on the photonic steering device 130 may transmit through the photonic steering device 130 and be focused in a direction of the waveguide 120, thereby increasing light coupling efficiency between the photonic source 110 and the waveguide 120.

The light incident from the photonic source 110 may be incident on a curved surface of the photonic steering device 130. The light incident on the curved surface may be differently refracted according to an angle of incidence, and thus focused while traveling through the photonic steering device 130.

The photonic steering device 130 may include a lens shape configured to enhance focusing of light. For example, the photonic steering device 130 may include a convex shape from the dielectric layer 102. A cross-section of the photonic steering device 130 may have, for example, a circular or oval shape. However, the shape of the photonic steering device 130 is not limited thereto, and may vary depending on a shape and a position of each of the photonic source 110 and the waveguide 120.

A material of the photonic steering device 130 may be similar to a material of at least one of the photonic source 110 and the waveguide 120. In addition, the photonic steering device 130 may include a material having a higher refractive index than the dielectric layer 102. Therefore, there may be little or no absorption of light transmitted through the photonic steering device 130. For example, the refractive index of the photonic steering device 130 may be a value between the refractive index of the photonic source 110 and the refractive index of the waveguide 120. For example, in at least one embodiment, the refractive index of the photonic steering device 130 may be within a range of about 2.5 to about 3.5.

Alternatively, when the waveguide 120 and the photonic steering device 130 are in contact with each other, the refractive index of the photonic steering device 130 may be less than or equal to the refractive index of the waveguide 120. Because the refractive index of the photonic steering device 130 is less than or equal to the refractive index of the waveguide 120, light reflection may be reduced on the interface between the waveguide 120 and the photonic steering device 130, thereby increasing light coupling efficiency.

The photonic steering device 130 may include at least one of an organic material, an oxide, and/or a nitride. In at least one embodiment, the photonic steering device 130 may be formed through a thermal flow process, a gray scale photo process, etc.

Although not shown in FIG. 1, the photonic integrated apparatus may further include an electrode that applies an electrical signal to the photonic source 110.

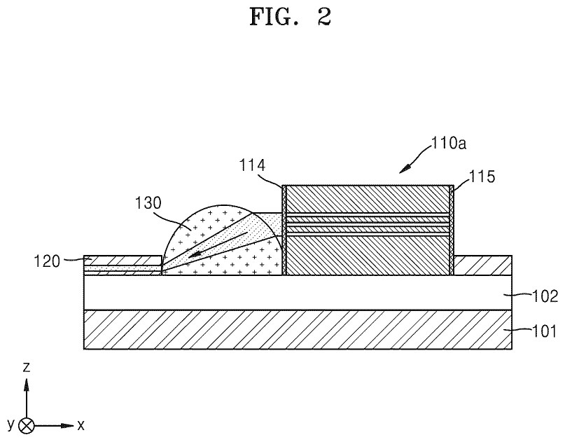

FIG. 2 is a diagram illustrating a photonic integrated apparatus further including an anti-reflective layer 114 and a reflective layer 115 according to at least one embodiment.

Upon comparing FIG. 1A with FIG. 2, a photonic source 110a of FIG. 2 may include the anti-reflective layer 114 and the reflective layer 115. The anti-reflective layer 114 may be disposed on a surface among side surfaces of the photonic source 110a that faces the photonic steering device 130, and the reflective layer 115 may be disposed on at least one of the remaining surfaces of the photonic source 110 on which the anti-reflective layer 114 is not disposed.

The anti-reflective layer 114 may be configured to prevent light generated by the photonic source 110a from being reflected from an interface of the photonic source 110a into the photonic source 110a. For example, a wavelength reflected from the interface between the anti-reflective layer 114 and the photonic source 110a may be destructively interfered so that reflectance into the photonic source 110a may be reduced and the transmittance to the outside of the photonic source 110a may be improved. The anti-reflective layer 114 may include at least one of MgF₂, SiO₂, Al2O₃. and/or HfO₂, and may be patterned to destructively interfere with the reflected wavelength, but is not limited thereto. This may increase the light emission efficiency of the photonic source 110a.

The reflective layer 115 may reflect the light generated by the photonic source 110a into the interior of the photonic source 110a, thereby preventing the light from being emitted towards a place other than the photonic steering device 130 and/or increasing the energy efficiency of the photonic source 110a. The reflective layer 115 may include a semiconductor material and/or a dielectric material having high reflectivity. For example, the reflective layer 115 may include a group III-V compound semiconductor or a group II-VI compound semiconductor having high reflectivity, e.g., with respect to the wavelength of light generated by the photonic source 110a.

The photonic source 110a in FIG. 2 is shown as including the anti-reflective layer 114 and the reflective layer 115, but is not limited thereto. The photonic source 110a may include only one of the anti-reflective layer 114 and the reflective layer 115.

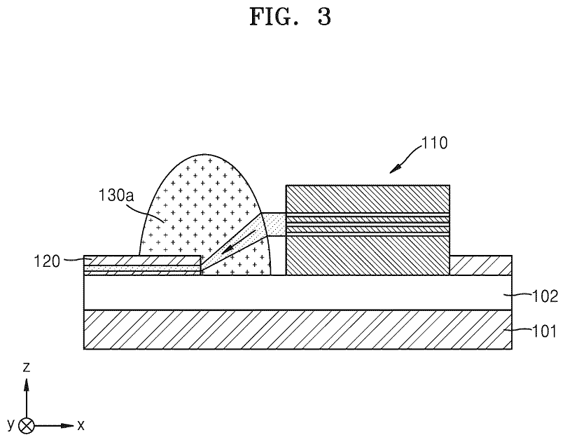

FIG. 3 is a diagram illustrating a photonic integrated apparatus in which the waveguide 120 and the photonic steering device 130a overlap according to at least one embodiment. Upon comparing FIG. 3 to FIG. 1A (and FIG. 2), the photonic steering device 130a may be disposed to overlap the waveguide 120. For example, the photonic steering device 130a may overlap the waveguide 120 in a thickness direction of the substrate 101. A refractive index of the photonic steering device 130a may be less than or equal to a refractive index of the waveguide 120. Thus, light output from the photonic steering device 130a may be incident into the waveguide 120 at low reflectivity from an interface between the photonic steering device 130a and the waveguide 120. A distance between a photonic source and the photonic steering device 130a may be reduced, and thus, a compact photonic integrated apparatus may be implemented.

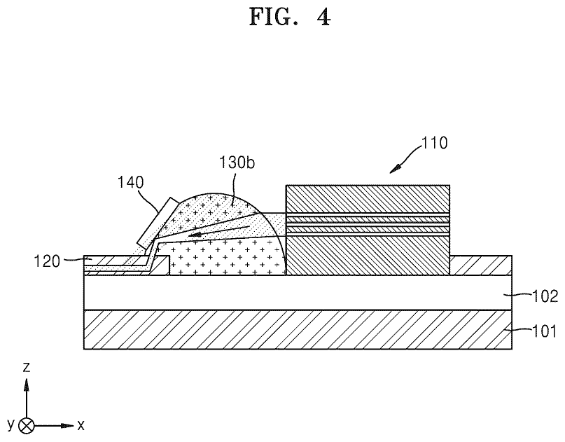

FIG. 4 is a diagram illustrating a photonic integrated apparatus including a reflector 140 according to at least one embodiment. Upon comparing FIG. 3 with FIG. 4, the reflector 140 may be further disposed on a surface of a photonic steering device 130b. The reflector 140 may reflect light incident through the photonic steering device 130b at a certain angle, thereby controlling steering of the light more effectively. The reflector 140 may include a metal material having high reflectivity, such as Ag, Au, Pt, Ni, Cr, and/or Al, but is not limited thereto.

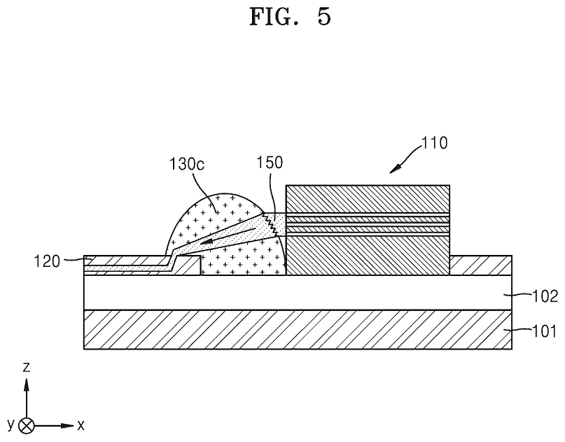

FIG. 5 is a diagram illustrating a photonic integrated apparatus including a diffractive optical device 150 according to at least one embodiment. Comparing FIG. 5 to FIG. 3, the diffractive optical device 150 may be disposed on a surface of a photonic steering device 130c. The diffractive optical device 150 may be (and/or include) a grating such as an echelle grating, a holographic grating, a volume holographic grating, a volume Bragg grating, and/or the like. The diffractive optical device 150 may diffract light emitted from the photonic source 110, thereby steering the light more effectively. For example, the photonic source 110 may be tuned to emit light of multiple wavelengths. The Echelle grating may steer light so as to be incident on the waveguide 120 at the same angle even though light of different wavelengths is emitted from the photonic source 110.

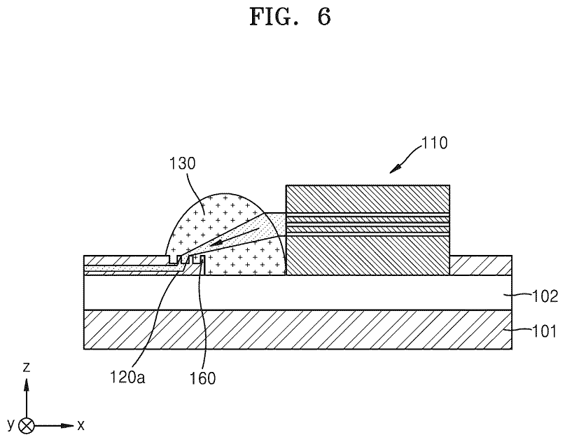

FIG. 6 is a diagram illustrating a photonic integrated apparatus including a photonic coupler 160 according to at least one embodiment. Comparing FIG. 6 to FIG. 3, the photonic coupler 160 may be disposed on a waveguide 120a of FIG. 6. The photonic coupler 160 may be configured to allow light incident from the outside of the waveguide 120a to travel to the inside of the waveguide 120a. For example, the photonic coupler 160 may be in the form of (and/or include) a periodic grating. As shown in FIG. 6, a material of the waveguide 120a, for example, a silicon material, may be patterned to be integrally formed with the waveguide 120a. However, the waveguide 120a is not limited thereto.

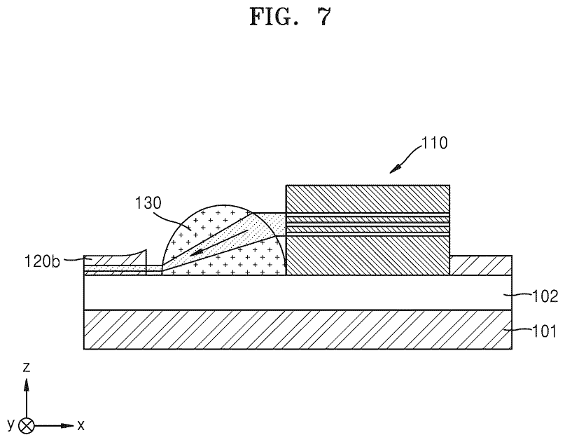

FIG. 7 is a diagram illustrating a photonic integrated apparatus including a waveguide 120b having a tapered shape according to at least one embodiment. Comparing FIG. 7 to FIG. 1A (and FIG. 2), a thickness of an area of the waveguide 120b where light is incident on the photonic steering device 130 may be greater than a thickness of the remaining area. For example, the waveguide 120b may have a tapered shape gradually decreasing in thickness from an end thereof to a center area. In the drawing, the thickness of the waveguide 120b gradually decreases, but is not limited thereto. A width of the waveguide 120b may gradually decrease from the end thereof. The waveguide 120b having the tapered shape may receive a greater amount of light from the photonic steering device 130.

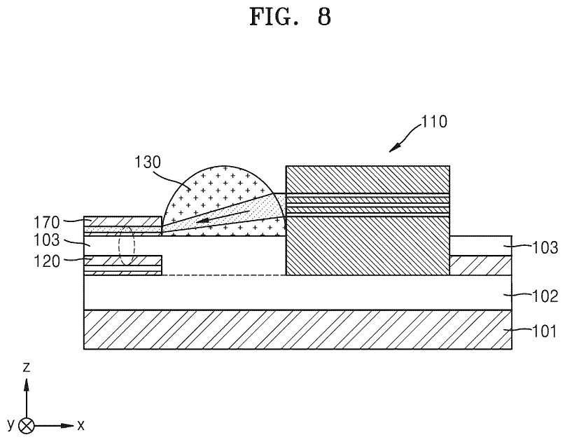

FIG. 8 is a diagram illustrating a photonic integrated apparatus including a plurality of waveguides 120 according to at least one embodiment. Upon comparing FIG. 1A (and FIGS. 2 and 3) with FIG. 8, the dielectric layer 102 shown in FIGS. 1A and 8 may be referred to as a first dielectric layer, and the waveguide 120 may be referred to as a first waveguide. The photonic integrated apparatus of FIG. 8 may further include a second dielectric layer 103 disposed on the first waveguide 120. Here, the second dielectric layer 103 may protect the first waveguide 120 by covering the first waveguide 120. A second waveguide 170 may be further disposed on the second dielectric layer 103. The photonic steering device 130 may be disposed on the second dielectric layer 103, and the first semiconductor layer 111 of the photonic source 110 may be exposed on an upper surface of the second dielectric layer 103.

A partial area of the first waveguide 120 and a partial area of the second waveguide 170 may overlap each other in a thickness direction of the first dielectric layer 102. When a distance between the first waveguide 120 and the second waveguide 170 is less than or equal to a wavelength of light, vertical evanescent coupling may occur in an opposing area of the first waveguide 120 and the second waveguide 120 so that the light may be transmitted between the first waveguide 120 and the second waveguide 170 with little light loss.

When a height difference between the active layer 112 of the photonic source 110 and the first waveguide 120 is large, and when light coupling between the photonic source 110 and the first waveguide 120 is difficult using only the photonic steering device 130, the light may be transmitted with little light loss by adding the second dielectric layer 103 and the second waveguide 170.

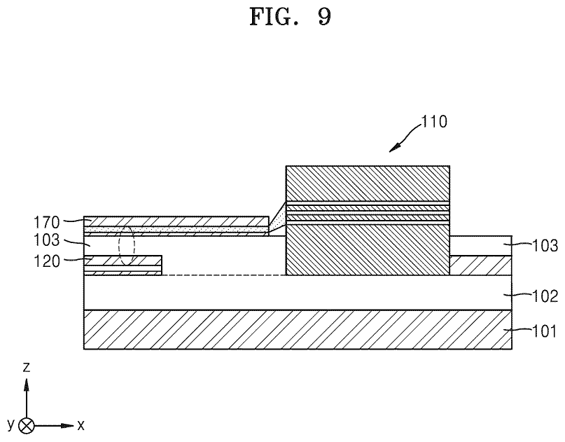

FIG. 9 is a diagram illustrating a photonic integrated apparatus including the second waveguide 170 according to at least one embodiment. Upon comparing FIG. 8 with FIG. 9, the photonic integrated apparatus of FIG. 9 may not include the lens-shaped photonic steering device 130. The second waveguide 170 may receive light incident from the photonic source 110 and couple the light to the first waveguide 120. The second waveguide 170, which changes a traveling path of light, may be referred to as a photonic steering device in a broad view.

A connection structure between the photonic source 110 and the waveguide 120 has been described above. However, the disclosure is not limited thereto. The same may be applied to a connection structure between a photonic detector and a waveguide. The only difference is that the photonic source 110 is a photonic device that converts an electrical signal into light, while the photonic detector is a photonic device that converts light into an electrical signal, and the photonic detector may also include a group III-V compound semiconductor or a group II-VI compound semiconductor.

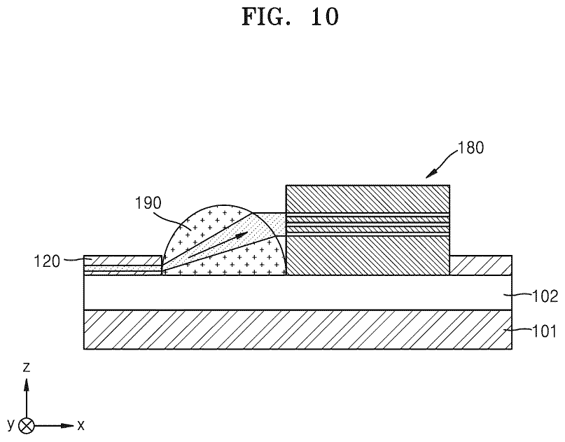

FIG. 10 is a diagram illustrating a photonic integrated apparatus including the waveguide 120 and a photonic detector 180 according to at least one embodiment. Referring to FIG. 10, the photonic detector 180 may convert light received from the waveguide 120 into an electrical signal. The photonic detector 180 may be in contact with the substrate 101 through the opening O included in the first dielectric layer 102, and may include a first semiconductor layer, the active layer, and a second semiconductor layer. A structure of the photonic detector 180 is substantially the same as the photonic source 110 described with reference to FIGS. 1A and 1B, and thus, a detailed description thereof is omitted. However, the active layer of the photonic detector 180 may convert the received light into electrical energy.

A photonic steering device 190 may be disposed between the waveguide 120 and the photonic detector 180. The photonic steering device 190 may steer the light received from the waveguide 120 and apply the light to the photonic detector 180.

The photonic steering device 190 may include a lens shape that enhances focusing of the light. For example, the photonic steering device 190 may include a convex shape from the dielectric layer 102. A material of the photonic steering device 190 may be similar to a material of any one of the waveguide 120 and the photonic detector 180. In addition, the photonic steering device 190 may include a material having a higher refractive index than the dielectric layer 102.

Alternatively, when the photonic steering device 190 is in contact with the photonic detector 180, a refractive index of the photonic steering device 190 may be less than or equal to a refractive index of the photonic detector 180. Because the refractive index of the photonic steering device 190 is less than or equal to the refractive index of the photonic detector 180, light reflection may be reduced on an interface between the photonic steering device 190 and the photonic detector 180, thereby increasing light coupling efficiency.

FIGS. 3, 4, 6, and 7 may be applied to relationships between the waveguide 120 and the photonic steering device 190, and thus, detailed descriptions thereof are omitted. In addition, relationships between the first waveguide 120, the second waveguide 170, the photonic steering device 190, and the photonic detector 180 are similar to relationships between the first waveguide 120, the photonic steering device 130, and the photonic source 120 of FIGS. 8 and 9, and thus, detailed descriptions thereof are omitted.

The photonic integrated apparatus may be applied to various fields. For example, the photonic integrated apparatus may be applied to a photonic sensor such as a laser radar (LiDAR) for autonomous driving, a photonic link, a photonic computing apparatus, a photonic memory apparatus, etc.

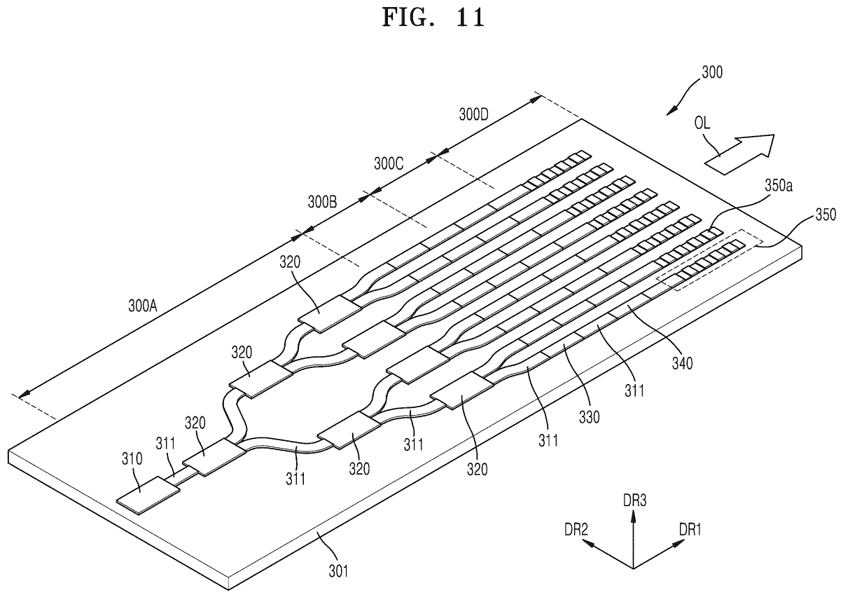

FIG. 11 is a perspective view schematically illustrating a configuration of an optical phase array device 300 which is an example of a photonic integrated apparatus according to at least one embodiment. Referring to FIG. 11, the optical phase array device 300 may include a photonic source 310, a branching area 300A, a phase control area 300B, an amplification area 300C, and an emission area 300D disposed on a substrate 301. The photonic source 310, the branching arca 300A, the phase control area 300B, the amplification area 300C, and the emission area 300D may be arranged in a first direction DR1. In addition, the optical phase array device 300 may include a plurality of waveguides 311 that sequentially transmit light generated from the photonic source 310 to the branching area 300A, the phase control area 300B, the amplification area 300C, and the emission area 300D. The light generated from the photonic source 310 may travel in the first direction DR1 through the waveguides 311. The photonic source 310 may include, for example, at least one of the embodiments discussed above with regards to FIGS. 1A through 9.

The branch area 300A may include a plurality of optical splitters 320. The plurality of optical splitters 320 may divide one light traveling along the waveguides 311 into several lights. To this end, one waveguide 311 may be connected to an input terminal of each of the optical splitters 320, and the plurality of waveguides 311 may be connected to an output terminal of the optical splitters 320. As an example, FIG. 11 illustrates the plurality of optical splitters 320 that divide one light into two lights. The light generated from the photonic source 310 may be divided into a plurality of lights within the branch area 300A. The plurality of divided lights respectively travel along the plurality of waveguides 311. In FIG. 11, the light generated from the photonic source 310 is shown to be divided into eight lights in the branch area 300A, but this is a simple example and is not necessarily limited thereto.

The phase control area 300B may include a plurality of phase control devices 330 respectively disposed in the plurality of waveguides 311. For example, the plurality of phase control devices 330 may be arranged in a second direction DR2 perpendicular to the first direction DR1. The plurality of lights divided within the branch area 300A may be respectively provided to the plurality of phase control devices 330. Each of the phase control devices 330 may have a variable refractive index that is electrically controlled. Phases of lights passing through the phase control devices 330 may be determined according to a refractive index of each of the phase control devices 330. The phase control devices 330 may independently adjust the phases of the divided lights.

The amplification area 300C may include a plurality of optical amplifiers 340 respectively disposed in the plurality of waveguides 311. The plurality of optical amplifiers 340 may be arranged in the second direction DR2 perpendicular to the first direction DR1. The optical amplifier 340 may increase the magnitude of an optical signal. For example, each of the optical amplifiers 340 may include a semiconductor optical amplifier or an ion-doped amplifier.

The emission area 300D may include a plurality of lattice pattern groups 350. The plurality of lattice pattern groups 350 may be arranged in the second direction DR2. The plurality of lattice pattern groups 350 may each be connected to a plurality of optical amplifiers 340. The lattice pattern groups 350 may respectively emit lights amplified in the amplification region 300C. To this end, the lattice pattern groups 350 may respectively include a plurality of lattice patterns 350a which are arranged periodically. The plurality of lattice patterns 350a may be arranged in the first direction DR1. A direction in which an output light OL emitted by the lattice pattern groups 350 travels may be determined according to a phase difference between the divided lights determined in the phase control area 300B, a distance between the lattice patterns 350a, a height of each of the lattice patterns 350a, and a width of each of the lattice patterns 350a. For example, the direction in which the output light OL travels may include a component in the first direction DR1, a component in the second direction DR2, and a component in a third direction DR3 perpendicular to the first direction DR1 and the second direction DR2.

According to at least one embodiment, a compact photonic integrated apparatus may be implemented by growing a photonic device directly on a substrate.

According to at least one embodiment, a photonic steering device may be disposed between the photonic device and the waveguide, thereby reducing degradation of light coupling due to a height difference between the photonic device and the waveguide.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A photonic integrated apparatus comprising:
a substrate;
a dielectric layer on the substrate, the dielectric layer defining an opening exposing a part of the substrate;
a photonic source contacting a partial area of the substrate through the opening;
a waveguide on the dielectric layer; and
a photonic steering device on the dielectric layer and configured to steer light emitted from the photonic source to the waveguide.

2. The photonic integrated apparatus of claim 1, wherein a partial area of at least one side surface of the photonic source is in contact with the dielectric layer.

3. The photonic integrated apparatus of claim 1, wherein the substrate includes one or more grooves.

4. The photonic integrated apparatus of claim 3, wherein the one or more grooves expose a (111) surface of the substrate.

5. The photonic integrated apparatus of claim 3, wherein the photonic source fills at least one of the one or more grooves.

6. The photonic integrated apparatus of claim 1, wherein the photonic source includes:
a first semiconductor layer in contact with a partial area of the substrate;
a second semiconductor layer above the first semiconductor layer; and
an active layer between the first semiconductor layer and the second semiconductor layer, and
wherein a portion of the first semiconductor layer protrudes from the dielectric layer.

7. The photonic integrated apparatus of claim 6, wherein the first semiconductor layer includes:
a first sub-semiconductor layer surrounded by the dielectric layer; and
a second sub-semiconductor layer on the first sub-semiconductor layer and having a width different from a width of the first sub-semiconductor layer.

8. The photonic integrated apparatus of claim 7, wherein the width of the second sub-semiconductor layer is greater than the width of the first sub-semiconductor layer.

9. The photonic integrated apparatus of claim 1, wherein the photonic steering device is configured to focus the light emitted from the photonic source toward the waveguide.

10. The photonic integrated apparatus of claim 1, wherein the light emitted from the photonic source is incident on a curved surface of the photonic steering device.

11. The photonic integrated apparatus of claim 1, wherein the photonic steering device is in contact with at least one of an upper surface or a side surface of the waveguide.

12. The photonic integrated apparatus of claim 1, wherein the waveguide overlaps a part of the photonic steering device in a thickness direction of the substrate.

13. The photonic integrated apparatus of claim 1, wherein a refractive index of the photonic steering device is less than or equal to a refractive index of the waveguide.

14. The photonic integrated apparatus of claim 1, wherein the substrate includes a semiconductor.

15. The photonic integrated apparatus of claim 1, wherein the substrate, the dielectric layer, the photonic source, and the waveguide have a monolithic structure.

16. The photonic integrated apparatus of claim 1, wherein the substrate, the dielectric layer, and the waveguide are patterned from a silicon on insulator (SOI) substrate.

17. The photonic integrated apparatus of claim 1, further comprising:
an anti-reflective layer on at least a part of a surface of the photonic source facing the photonic steering device.

18. The photonic integrated apparatus of claim 1, further comprising:
a reflective layer on at least a part of a surface of the photonic source not facing the photonic steering device.

19. The photonic integrated apparatus of claim 1, further comprising:
a reflector on the photonic steering device and configured to reflect incident light emitted from the photonic source.

20. The photonic integrated apparatus of claim 1, further comprising:
an additional dielectric layer over the waveguide; and
an additional waveguide over the additional dielectric layer and configured to transmit the light emitted from the photonic steering device to the waveguide through light coupling.
